(19) United States
(12) Patent Application Publication
(10) Pub. No.: US 2016/0168830 A1
(43) Pub. Date: Jun. 16, 2016

(54) Bathtub Spout Adapter For Hose Or Sprayer Coupling

(71) Applicant: Steve Medina, Austin, TX (US)

(72) Inventor: Steve Medina, Austin, TX (US)

(21) Appl. No.: 15/049,310

(22) Filed: Feb. 22, 2016

Related U.S. Application Data
(63) Continuation-in-part of application No. 14/329,091, filed on Jul. 11, 2014.

(51) Int. Cl. E03C 1/04; F16L 33/00

(52) U.S. Cl. CPC E03C 1/0403; E03C 1/0408; F16L 33/00

(57) ABSTRACT

The present disclosure provides a plumbing adapter for coupling a hose and a spout. The plumbing adapter is provided as a plumbing assembly. The plumbing adapter includes a first portion having a hose pipe, a second portion having a support assembly and a third portion having a lock assembly. The hose pipe connects to a tap spout of a water dispensing system. The support assembly includes two parallel arms to support the hose pipe at a first side. The lock assembly includes a pivoting assembly. The pivoting assembly includes a lever component, an arm component and a vertical threaded post connecting the lever component and the arm component at a second side. The pivoting assembly rotates to enable the plumbing assembly to make a transition between a lock position and an unlock position when the hose pipe is connected to the tap spout of the water dispensing system.

### CROSS-REFERENCE TO RELATED APPLICATIONS

This applications claims priority to U.S. Non-Provisional Patent Application Ser. No. 14/329,091, filed Jul. 11, 2014, which is hereby incorporated by reference in its entirety.

### FIELD OF THE INVENTION

The present invention relates to the field of coupling a hose to a spout and, in particular, relates to the field of providing a device or an adapter to enable coupling of the hose to the spout.

### BACKGROUND OF THE INVENTION

In the present era, various types of fluid supply accessories, usable with taps/faucets/spigots, are available. Examples of the fluid supply accessories include but may not be limited to spouts, hoses, diverters and adapters. The fluid supply accessories are used with the taps/faucets/spigots of domestic bath taps, showers and the like. For example, a hose is connected to a spout of the tap/faucet/spigot to enable working of showers, domestic bath taps and the like. The tap/faucet/spigot is a valve assembly for controlling release of fluids. The fluid supply accessories are devices used as attachments/couplings to the tap/faucet/spigot and enable utilization of the tap/faucet/spigot for various purposes.

Presently, the fluid supply accessories are not compatible with each other due to differences and inconsistencies in sizes and designs of each of the taps/faucets/spigots and the fluid supply accessories. Thus, coupling or attachment of the taps/faucets/spigots and the fluid supply accessories results in leakage of fluids from the taps/faucets/spigots. Moreover, coupling connections between the taps/faucets/spigots and the fluid supply accessories are not stable. More specifically, connection of the hose to the spout of the tap/faucet/spigot is not stable. Thus, there is a need for a device or an adapter that provides a stable connection/coupling of the hose to the spout and prevents leakage.

### BRIEF SUMMARY OF THE INVENTION

In an aspect of the present disclosure, a plumbing assembly is provided. The plumbing assembly includes a plumbing adapter. The plumbing adapter includes a first portion having a hose pipe, a second portion having a support assembly and a third portion having a lock assembly. The hose pipe connects to a tap spout of a water dispensing system. The support assembly includes two parallel arms to support the hose pipe at a first side. The lock assembly includes a pivoting assembly. The pivoting assembly includes a lever component, an arm component and a vertical threaded post connecting the lever component and the arm component at a second side. The pivoting assembly rotates to enable the plumbing assembly to make a transition between a lock position and an unlock position when the hose pipe is connected to the tap spout of the water dispensing system.

In an embodiment of the present disclosure, the plumbing assembly includes a gasket to provide a leak-proof stable connection of the plumbing assembly to the tap spout when the hose pipe is connected to the tap spout of the water dispensing system in the lock position.

In an embodiment of the present disclosure, the lock assembly includes a clasp mechanism configured to connect a first end of the arm component to a first arm of the two parallel arms through a hook of the first arm. The clasp mechanism includes a C shaped steel clasp and the clasp mechanism enables the pivoting assembly to rotate around the first portion of the tap spout to enable the plumbing assembly to make the transition between the lock position and the unlock position.

In an embodiment of the present disclosure, the lock assembly includes a hinge assembly to connect a second end of the arm component to a second arm of the two parallel arms. The hinge assembly enables the pivoting assembly to rotate around the first portion of the tap spout to enable the plumbing assembly to make the transition between the lock position and the unlock position.

In an embodiment of the present disclosure, the lever component rotates towards left at an angle of 90 degrees, enables moving of the vertical threaded post down onto a spout diverter valve and creates a pressure to seat a gasket in the first portion.

In an embodiment of the present disclosure, the rotation of the pivoting assembly to make the transition between the lock position and the unlock position prevents an obstruction of the spout diverter valve.

In an embodiment of the present disclosure, the plumbing assembly includes a fulcrum to adjust the plumbing assembly to the liquid dispensing system.

In an embodiment of the present disclosure, the fulcrum fixes the pivoting assembly at a locking point of the liquid dispensing system.

In an embodiment of the present disclosure, the hose pipe is a male hose connector and the male hose connector connects to the tap spout of the water dispensing system.

In another embodiment of the present disclosure, the hose pipe is a female hose connector and the female hose connector connects to the tap spout of the water dispensing system.

In another aspect of the present disclosure, a plumbing assembly is provided. The plumbing assembly includes a plumbing adapter. The plumbing adapter includes a first portion having a hose pipe, a second portion having a support assembly, a third portion having a lock assembly and a gasket. The hose pipe is configured to connect to a tap spout of a water dispensing system. The support assembly includes two parallel arms configured to support the hose pipe at a first side. The lock assembly includes a pivoting assembly. The pivoting assembly includes a lever component, an arm component and a vertical threaded post connecting the lever component and the arm component at a second side. The pivoting assembly rotates to enable the plumbing assembly to make a transition between a lock position and an unlock position when the hose pipe is connected to the tap spout of the water dispensing system. The gasket provides a leak-proof stable connection of the plumbing assembly to the tap spout when the hose pipe is connected to the tap spout of the water dispensing system in the lock position.

In an embodiment of the present disclosure, the lock assembly includes a clasp mechanism to connect a first end of the arm component to a first arm of the two parallel arms through a hook of the first arm. The clasp mechanism includes a C shaped steel clasp and the clasp mechanism enables the pivoting assembly to rotate around the first portion of the tap spout to enable the plumbing assembly to make the transition between the lock position and the unlock position.

In an embodiment of the present disclosure, the lock assembly further includes a hinge assembly to connect a second end of the arm component to a second arm of the two parallel arms. The hinge assembly enables the pivoting assembly to rotate around the first portion of the tap spout to enable the plumbing assembly to make the transition between the lock position and the unlock position.

In an embodiment of the present disclosure, the lever component rotates towards left at an angle of 90 degrees, enables moving of the vertical threaded post down onto a spout diverter valve and creates a pressure to seat the gasket in the first portion.

In an embodiment of the present disclosure, the rotation of the pivoting assembly to make the transition between the lock position and the unlock position prevents an obstruction of the spout diverter valve.

In an embodiment of the present disclosure, the plumbing assembly includes a fulcrum to adjust the plumbing assembly to the liquid dispensing system. The fulcrum fixes the pivoting assembly at a locking point of the liquid dispensing system.

In an embodiment of the present disclosure, the hose pipe is a male hose connector. The male hose connector connects to the tap spout of the water dispensing system.

In another embodiment of the present disclosure, the hose pipe is a female hose connector. The female hose connector connects to the tap spout of the water dispensing system.

In one embodiment of the present disclosure, an adapter may include: a hose pipe, which configured to connect to a tap spout of a water dispensing system. The adapter may further comprise a support assembly. An exemplary the support assembly may include a first arm and a second arm, the first arm and the second arm may be configured in a parallel arrangement and connect between a supporting base and an adapter head. An embodiment may include a lock assembly, which may be configured to selectably and removably fix the plumbing assembly to the tap spout of a water dispensing system.

In one embodiment, the lock assembly may be configured with a lever component, an arm component, and a vertical threaded post. In this arrangement, the lock assembly may vertically transition between a lock position and an unlock position, lowered and raised, for selectable engaging the tap spout.

One embodiment may also comprise a gasket. A gasket may be used to provide a stable connection between the plumbing assembly and the tap spout so as to limit leakage in the connection when the hose pipe is connected to the tap spout of the water dispensing system in the lock position.

In one embodiment, rotation of level component actuates a change in vertical position of the vertical threaded post down to selectable engage the plumbing assembly with a spout diverter valve to seat a gasket in the first portion.

In one embodiment, rotation of the locking mechanism to make the transition between the lock position and the unlock position prevents an obstruction of the spout diverter valve.

In one embodiment, a hose bracket may be included for selectably engaging with a hose pipe.

In one embodiment, the arm component and the vertical threaded post may be fixedly joined.

In one embodiment, the lever component and the vertical threaded post may be removably joined.

In one embodiment, the support assembly may be constructed of a single piece.

In one embodiment, the support assembly components may be fixedly joined.

In one embodiment, the support assembly components may be removably joined.

In yet another aspect of the present disclosure, a plumbing assembly is provided. The plumbing assembly includes a plumbing adapter. The plumbing adapter includes a first portion having a hose pipe, a second portion having a support assembly and a third portion having a lock assembly. The hose pipe is configured to connect to a tap spout of a water dispensing system. The support assembly includes two parallel arms configured to support the hose pipe at a first side. The lock assembly includes a pivoting assembly. The pivoting assembly includes a lever component, an arm component and a vertical threaded post connecting the lever component and the arm component at a second side. The pivoting assembly rotates to enable the plumbing assembly to make a transition between a lock position and an unlock position when the hose pipe is connected to the tap spout of the water dispensing system. The rotation of the pivoting assembly to make a transition between the lock position and the unlock position prevents an obstruction of a spout diverter valve.

In an embodiment of the present disclosure, the plumbing assembly includes a fulcrum configured to adjust the plumbing assembly to the liquid dispensing system. The fulcrum fixes the pivoting assembly at a locking point of the liquid dispensing system.

There is a need for a method and system that overcomes the above stated disadvantages and provides an efficient adapter for coupling the hose to the spout. Moreover, the method and system should provide the adapter that enables coupling of different sizes of the hoses and the spouts. Further, the method and system should provide the adapter that can be coupled and decoupled when needed. Furthermore, the method and system should provide the adapter that enables stable and leak-proof connection of the hose and the spout.

The plumbing adapter of the plumbing assembly has several advantages. The plumbing adapter enables coupling of variable size hose pipes to the tap spouts of the liquid dispensing system. Further, the plumbing adapter is made using high strength plastic material, thus increasing an efficiency of the plumbing adapter. In addition, the plumbing adapter can be coupled and decoupled to the liquid dispensing system when needed. Further, the plumbing adapter enables the stable and the leak-proof connection of the hose and the spout (as described above).

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

Having thus described the invention in general terms, reference will now be made to the accompanying drawings, which are not necessarily drawn to scale, and wherein:

FIG. 1 illustrates an adapter embodiment of the present disclosure.

FIG. 2 illustrates an adapter embodiment of the present disclosure with a contrasting hose pipe connector arrangement.

FIG. 3 illustrates an adapter embodiment of the present disclosure engaged with a tap spout of a liquid dispensing system.

FIG. 4 illustrates an adapter embodiment of the present disclosure connected and unengaged with a tap spout with the locking mechanism retracted.

FIG. 5 illustrates an exploded view of an adapter embodiment of the present disclosure.

FIGS. 6A and 6B illustrates front and rear perspective views of an adapter embodiment of the present disclosure.

FIG. 7 illustrates an adapter embodiment of the present disclosure engaged with a hose.

FIG. 8 illustrates an exploded view of an adapter embodiment of the present disclosure.

### DETAILED DESCRIPTION OF ILLUSTRATIVE EMBODIMENTS

Reference now should be made to the drawings, in which the same reference numbers are used throughout the different figures to designate the same components.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

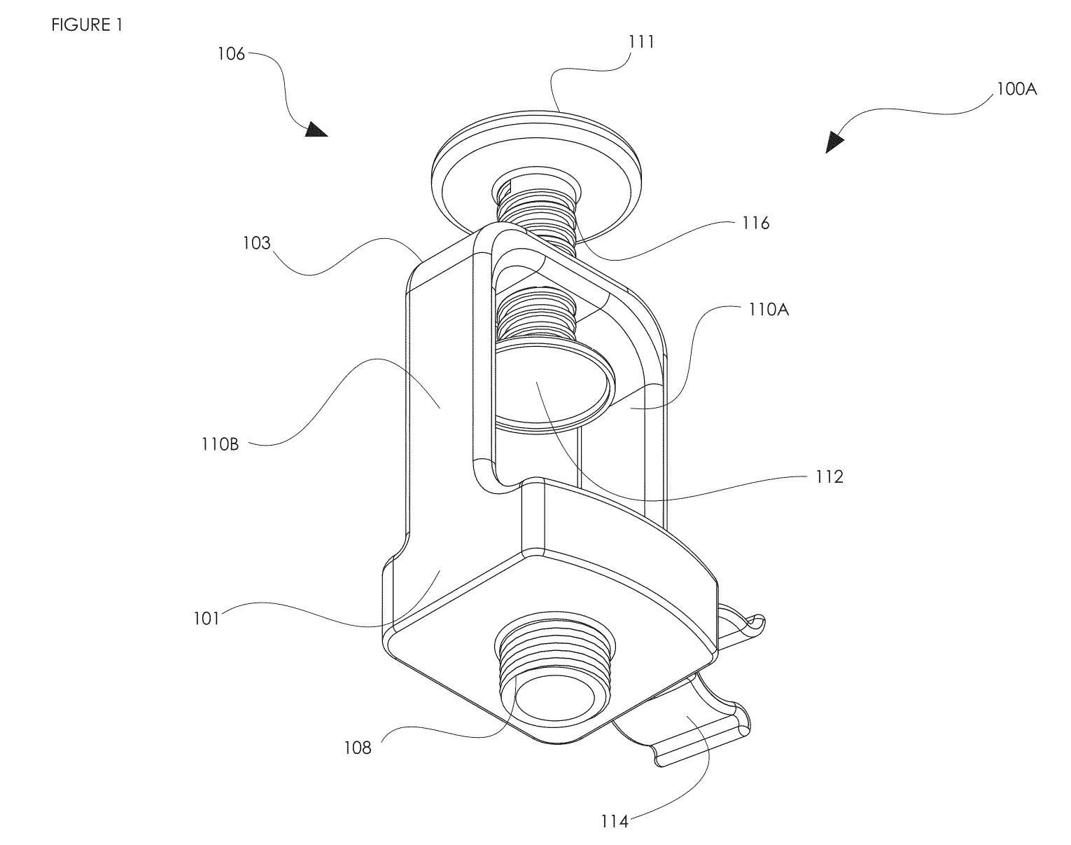

FIG. 1 illustrates an adapter embodiment in accordance with the present disclosure. As shown, an adapter embodiment may include a support assembly 104 having a supporting base 101, an adapter head 103, two parallel arms 110, a first arm 110A, and a second arm 110B. The two parallel arms 110 may connect to a supporting base 101 and an adapter head 103. In the arrangement shown, the adapter head 103 includes an orifice sized to accommodate a locking mechanism 106. A lock assembly 106 may be included into an embodiment for selectably engaging the embodiment with a water dispensing system. The embodiment may also include a connector 108, shown as a male connector in this arrangement, for selectably engaging and connecting a hose pipe to the adapter.

In the arrangement shown, the lock assembly 106 may selectably transition between a lock position and an unlocked position to engage with the tap spout 202 of the water dispensing system. In one arrangement, a lock assembly 106 may include a lever component or level foot 112, an arm component or lever head 111, and a vertical threaded post 116. The vertical threaded post 116 connects the lever foot 112 and the lever head 111.

Adapter embodiments may further include a hose holder bracket 114 on or more sides. A hose holder bracket may be used to selectably restrain or hold a connecting hose in proximity to the adapter.

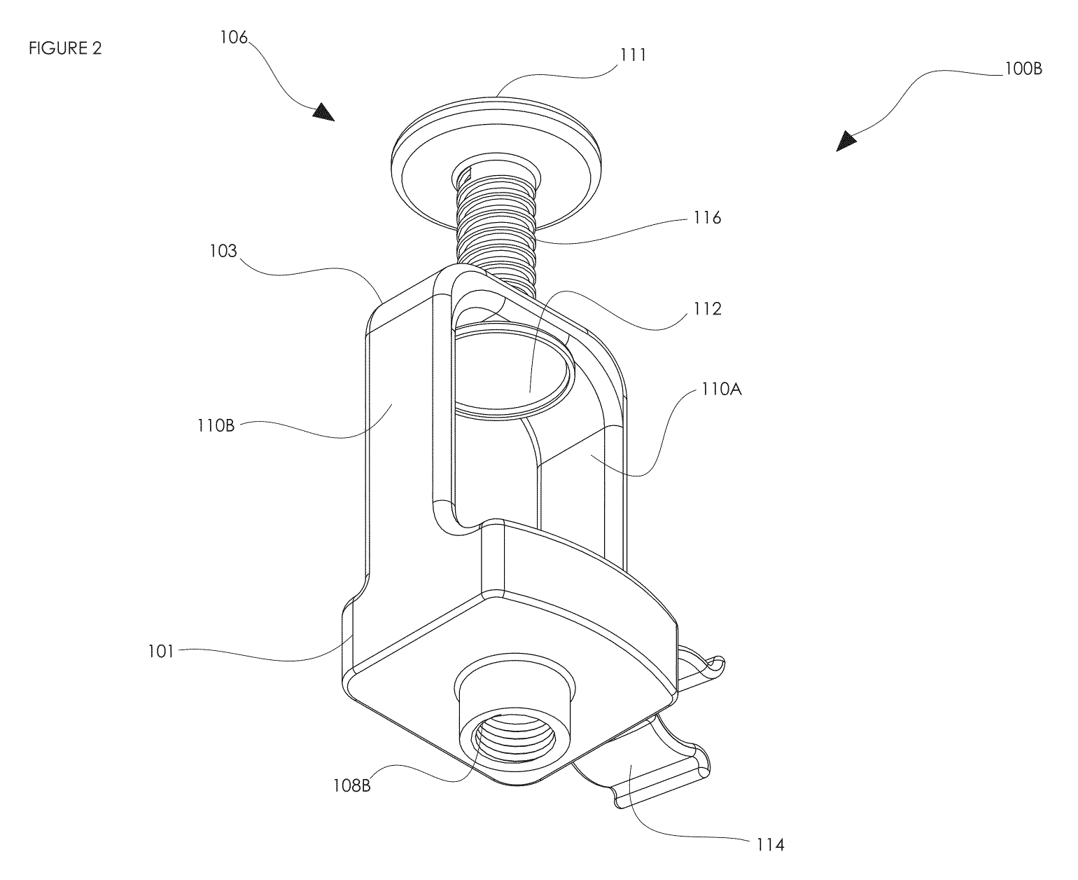

FIG. 2 illustrates a further embodiment of the present disclosure, which is similar in most respects to the embodiment shown in FIG. 1, but configured with a female hose adapter 108b.

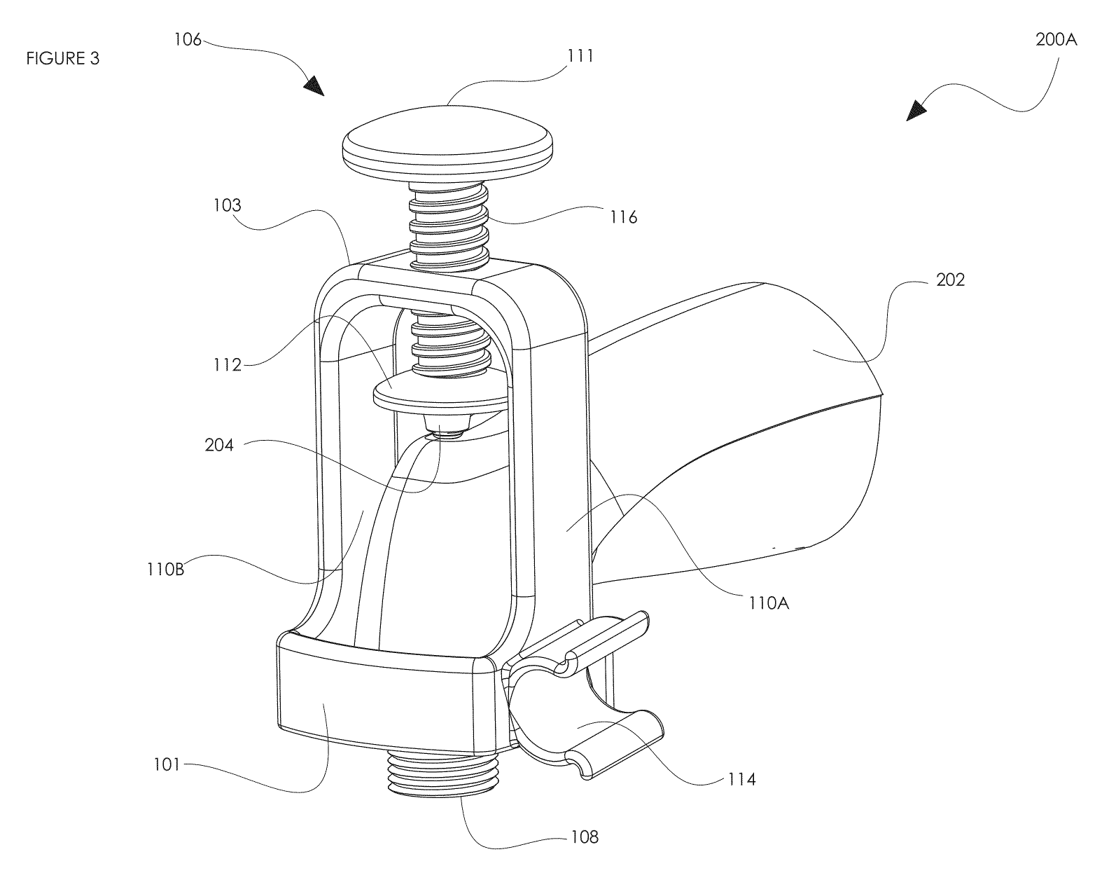

FIG. 3 illustrates an adapter embodiment 100 that has been selectably engaged with a tap spout 202. As shown, the vertical threaded post 116 may be rotated to transition between an extended and retracted position. In this arrangement, the adapter has been placed in a locked position by rotating the threaded post 216 to the extended position, which engages the adapter with the spout diverter valve 204.

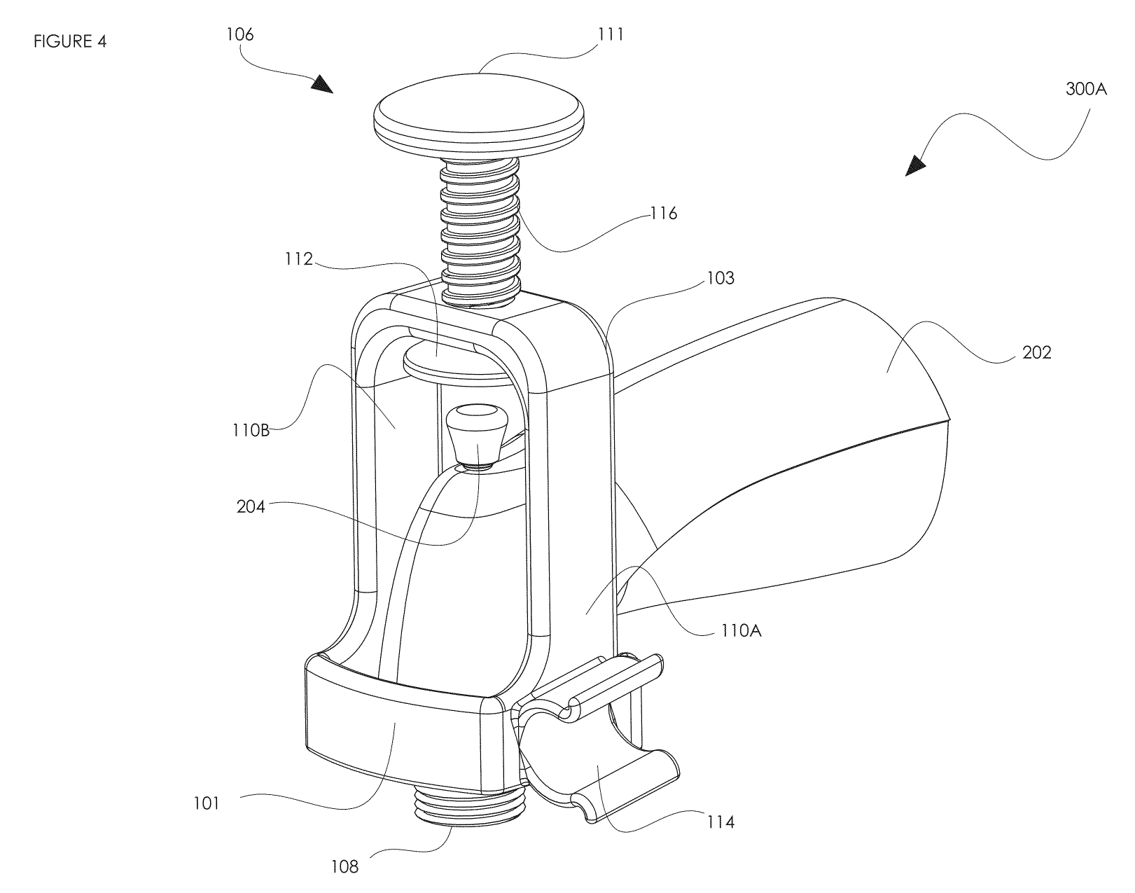

FIG. 4 illustrates an adapter embodiment 300A held in proximity of the tap spout either prior to engagement, or alternatively, after release of the adapter 300A. As shown, by rotating the threaded post 106 to the retreated position, the adapter 300A may either be placed for engagement with the tap spout 202, or may release the tap spout 202 after previous engagement.

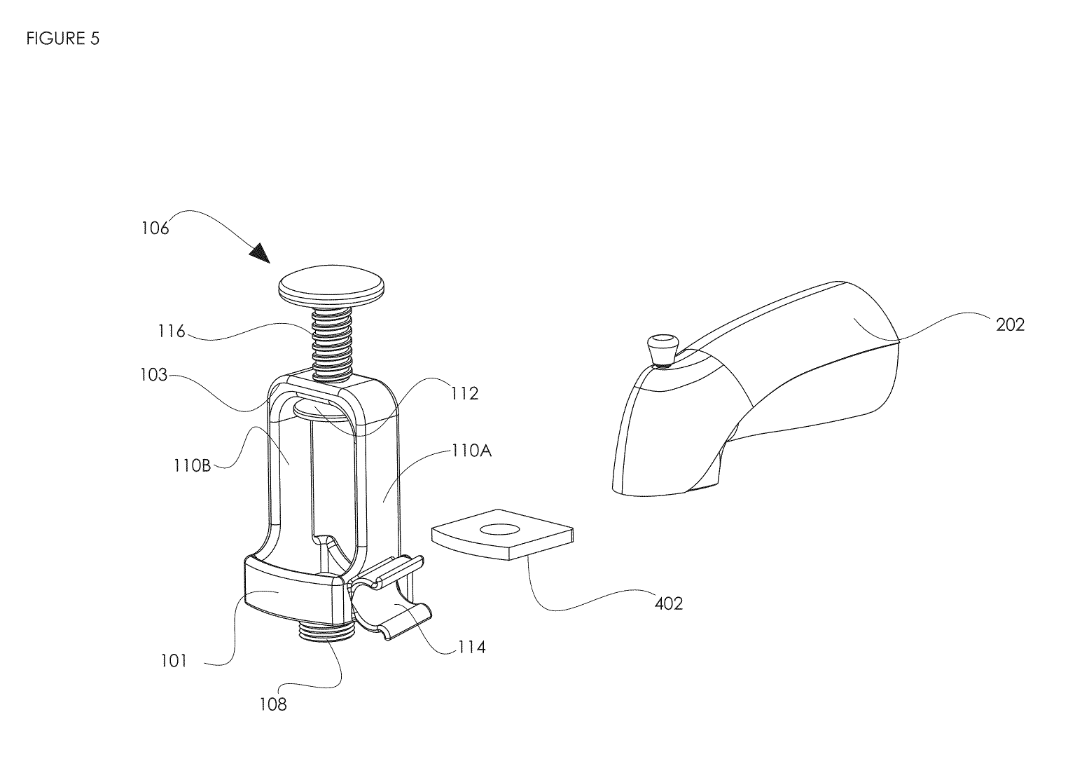

FIG. 5 illustrates an exploded view of an adapter embodiment, including the adapter base 103, adapter arms 110A and 110B, adapter head 103, locking mechanism 106, as well as a gasket 402 that may be included into an embodiment. As shown, a gasket 402 may be placed inside the adapter base whereby engagement of the adapter 100 with the tap spout 202 may seat a gasket 402 within the adapter. In an unlocked position, the lever component 116 of the pivoting assembly may be selectably rotated to the retreated position whereby the adapter may be removed from the spout diverter valve 202.

Some embodiments may include a well or recess for enclosing the tap spout, and a gasket 402. In some embodiments, the accommodated gasket 402 may be larger in dimensions than the tap spout. A gasket 402 may be used to provide a leak resistant stable connection to the tap spout when the hose pipe is connected to the adapter, and the adapter is in engaged to the tap spout in the lock position.

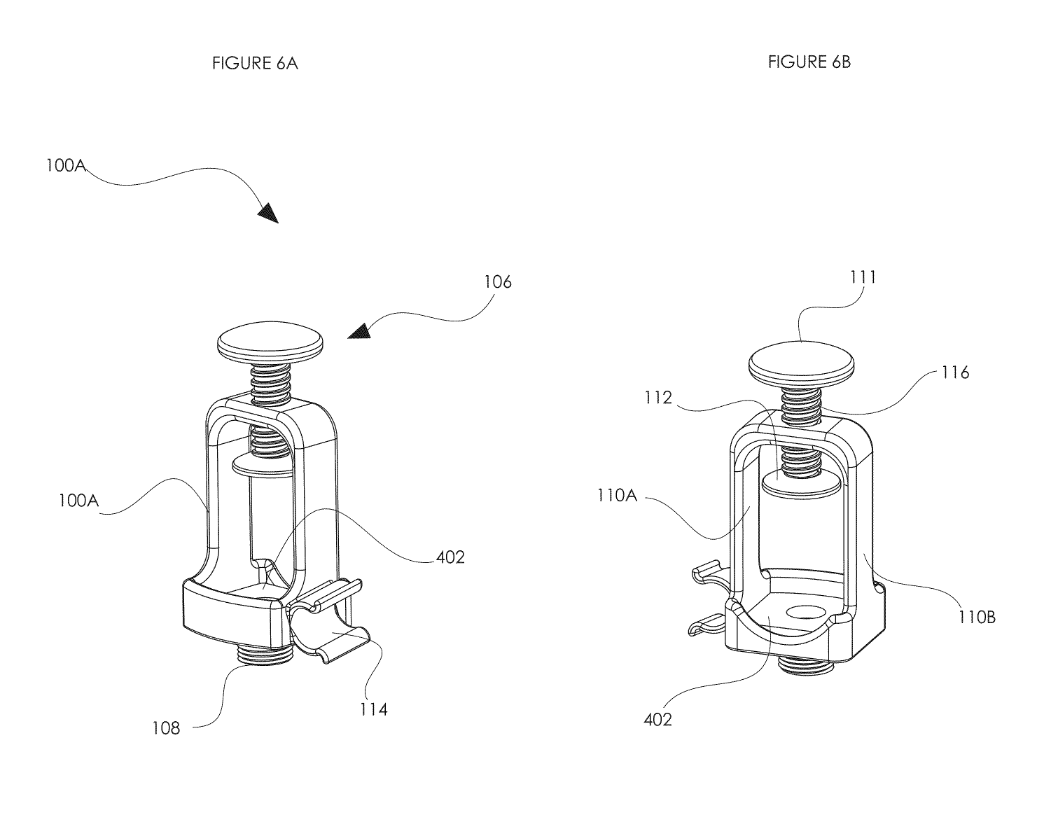

FIGS. 6A and 6B illustrates front and rear views of an adapter embodiment. As shown in FIG. 6B, a supporting base 101 may be fitted with a cutout for facilitating placement of the tap spout within the adapter.

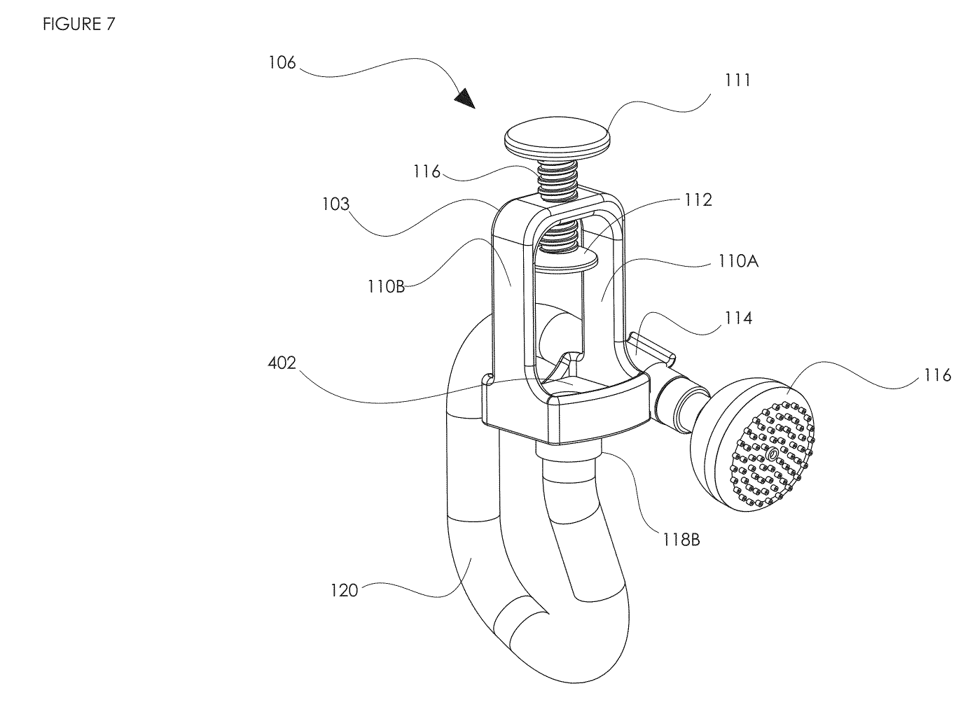

FIG. 7 illustrates an adapter embodiment 100 in a retracted position and engaged with a hose 120 and shower sprayer 118. Furthermore, the hose 120 is engaged with the hose holder bracket 114 for holding the hose pipe in proximity to the embodiment.

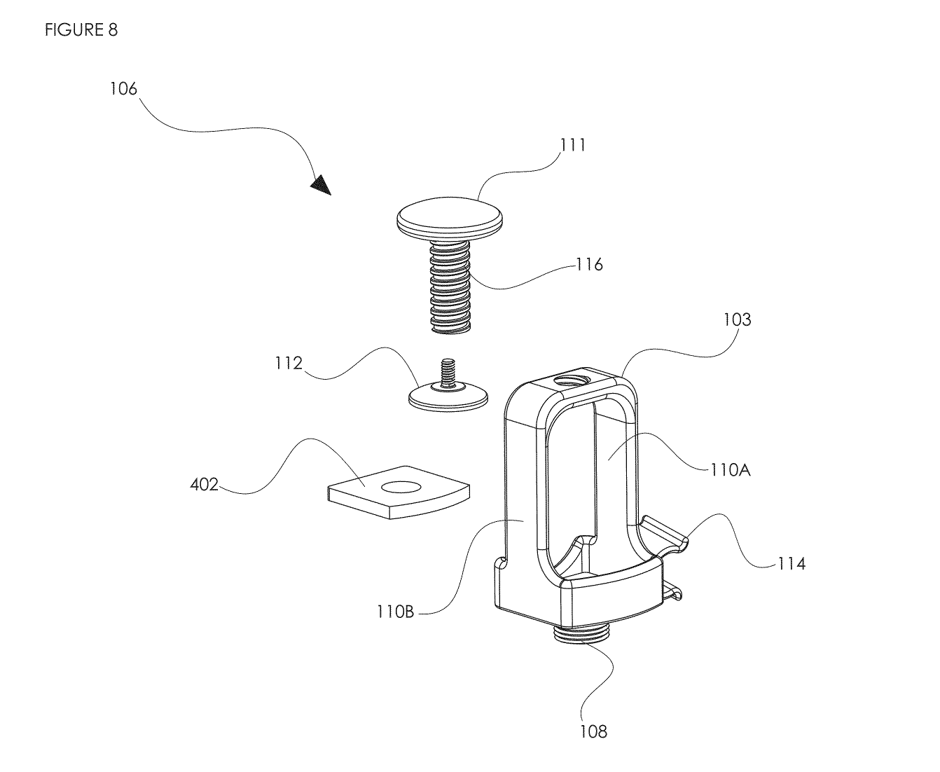

FIG. 8 illustrates an exploded view of an adapter embodiment of the present disclosure, including exploded componentry of the locking mechanism 106. As shown, one arrangement of the locking mechanism 106 may be a screw connection between the lever foot 112 and the vertical threaded post 116. The vertical threaded post 116 may further be fixedly connected to the lever head 111, and/or other arrangement as known in the art.

Wherein this disclosure make reference a male or female connector, it should be understood that specific hose to adapter connections are interchangeable without departing from the scope of the invention. Further embodiments may be configurable such that both male and female connections may be used with the same adapter. In yet further embodiments, adapter may be preconfigured for only one of a male or female connection. In yet further embodiments, unique connection arrangements may be used.

Some embodiment may be configurable to allow for, variable size hose pipes to be connected to the tap spouts of the liquid dispensing system 202.

One embodiment of the present disclosure may be constructed wholly, or partially of steel. One embodiment may contrasted wholly, or partially of plastic. Further embodiments may include composite materials, or combinations of materials. Various componentry of embodiments, e.g. arms, hinges, etc. may be constructed of different materials, e.g. a first arm may be steel while a hinge may be plastic, without departing from the scope of the present disclosure.

In yet another embodiment of the present disclosure, the plumbing adapter can be coupled and decoupled to the liquid dispensing system 202, when needed.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A plumbing assembly comprising:
a hose pipe connector;
a support assembly, the support assembly comprising:
a first arm and a second arm, the first arm and the second arm configured essentially parallel, the first arm and the second arm configured to support the hose pipe at a first side;
a supporting base;
an adapter head; and
a lock assembly for selectably and removably fixing the plumbing assembly to the tap spout of a water dispensing system.

2. The lock assembly of claim 1, the lock assembly comprising:
lever component;
an arm component; and
a vertical threaded post,
wherein the lock assembly vertically transitions between a lock position and an unlock position for selectable engaging the tap spout.

3. The plumbing assembly of claim 1, further comprising:
a gasket, the gasket configured to provide a stable connection of the plumbing assembly to the tap spout for limiting leakage in the connection when the hose pipe is connected to the tap spout of the water dispensing system in the lock position.

4. The plumbing assembly of claim 2, wherein rotation of level component actuates a change in vertical position of the vertical threaded post down to selectable engage the plumbing assembly with a spout diverter valve to seat a gasket in the first portion.

5. The plumbing assembly of claim 2, wherein the rotation of the pivoting assembly to make the transition between the lock position and the unlock position prevents an obstruction of the spout diverter valve.

6. The plumbing assembly of claim 1, wherein the hose pipe is a male hose connector, and wherein the male hose connector connects to the tap spout of the water dispensing system.

7. The plumbing assembly of claim 1, where wherein the hose pipe is a female hose connector, and wherein the female hose connector connects to the tap spout of the water dispensing system.

8. The plumbing assembly of claim 1, additional comprising a hose bracket for selectably engaging with a hose pipe.

9. The lock assembly of claim 2, wherein the arm component and the vertical threaded post are fixedly joined.

10. The lock assembly of claim 2, wherein the lever component and the vertical threaded post are removably joined.

11. The plumbing assembly of claim 1, wherein support assembly is constructed of a single piece.

12. The plumbing assembly of claim 1, wherein the support assembly components are fixedly joined.

13. The plumbing assembly of claim 1, wherein the support assembly components are removably joined.

14. The plumbing assembly of claim 1, wherein the supporting base comprises a cutout for accommodating placement of a tap spout.

15. The plumbing assembly of claim 1, configured to connect to a tap spout of a water dispensing system.

16. The plumbing assembly of claim 1, additional comprising:
a hose pipe connected to the hose pipe connector, wherein water emitted by a tap spout is passed through adapter to the hose pipe.
